(19) United States
(12) Patent Application Publication
(10) Pub. No.: US 2018/0148348 A1
(43) Pub. Date: May 31, 2018

(54) PROCESS OF USE OF ADSORBENT RESIN PARTICLES

(71) Applicants: Dow Global Technologies LLC, Midland, MI (US); Rohm and Haas Company, Philadelphia, PA (US)

(72) Inventors: Jia NING, Shanghai (CN); Zheng ZHANG, Shanghai (CN); Katariina MAJAMAA, Minneapolis, MN (US); Bie LI, Huzhou (CN); Qingwei CHU, Shanghai (CN); Zhaohui YAN, Shanghai (CN); Zhong Yun CHEN, Shanghai (CN)

(21) Appl. No.: 15/568,615

(22) PCT Filed: May 8, 2015
(86) PCT No.: PCT/CN2015/078522

§ 371 Date: Oct. 23, 2017

(51) Int. Cl. C02F 1/42; C02F 1/00; B01J 49/00

(52) U.S. Cl. CPC C02F 1/42; C02F 2303/16; B01J 49/00; C02F 1/006

(57) ABSTRACT

Provided is an apparatus for removing impurities from feed water comprising
(A) a loading tank comprising a top, a bottom, and an interior, and further comprising
   (i) an inlet that conveys the feed water to a water distributor,
   (ii) a grid located above the water distributor,
   (iii) an outlet located at a level higher than the grid,
   (iv) an outlet at the bottom of the loading tank,
(B) a regeneration tank comprising
   (i) a first inlet near the top of the regeneration tank,
   (ii) a second inlet at the top of the regeneration tank,
   (iii) an outlet at the bottom of the regeneration tank,
(C) a pipe that conveys material from the bottom of the regeneration tank to the top of the loading tank,
wherein said regeneration tank is located below the loading tank.

Also provided is a method of removing impurities by using such an apparatus.

It is a common practice to use adsorbent resin particles to remove impurities from feed water (that is, to purify the feed water). Adsorbent resin particles often provide either or both of the functions of (1) exchanging ions so as to remove unwanted ions from feed water and (2) adsorbing unwanted nonionic compounds from the feed water. Eventually, adsorbent resin particles will acquire a sufficient amount of impurities from the feed water that the adsorbent resin particles will no longer efficiently acquire a further amount of impurities, and it is then desirable to conduct a process of regeneration, in which the contaminated adsorbent resin particles are brought into contact with a regenerant liquid. Regenerant liquids are usually water, acid or base solutions, or salt solutions. Regenerant liquids are chosen to remove some or all of the impurities from the adsorbent resin particles.

It is desirable to provide a method and an apparatus for both removing impurities and regenerating adsorbent resin particles, preferably without the need for halting the process of purifying the feed water for a long time. US 2005/0173348 describes a method and apparatus for separating purifying media from a treated fluid. US 2005/0173348 teaches an apparatus that both purifies feed solution and regenerates resin; the apparatus taught by US 2005/0173348 has three separate tanks. It is desirable to provide a simplified method and apparatus for both purifying and regenerating that requires only two tanks.

The following is a statement of the invention.

A first aspect of the present invention is a method for removing impurities from feed water comprising
(a) providing a loading tank containing a collection of adsorbent resin particles, the collection having a top and a bottom,
(b) introducing the feed water into the bottom of the collection of the adsorbent resin particles,
(c) forcing the feed water upward through the collection of the adsorbent resin particles,
(d) passing the feed water through a grid located above the top of the collection of the adsorbent resin particles, wherein the grid prevents the passage of the adsorbent resin particles,
(e) allowing a portion of the collection of the adsorbent resin particles to fall from the bottom of the loading tank into a regeneration tank,
(f) introducing regenerant liquid into the regeneration tank
(g) after steps (e) and (f), in the regeneration tank, forming a mixture of contaminated regenerant liquid and purified adsorbent resin particles,
(h) after step (g), removing the contaminated regenerant liquid from the regeneration tank,
(i) after step (h), introducing pure water into the regeneration tank to form a mixture of the pure water and the purified adsorbent resin particles,
(j) after step (i), conveying the mixture of pure water and purified adsorbent resin particles to the loading tank and introducing the mixture of pure water and purified adsorbent resin particles onto the top of the collection of the adsorbent resin particles in the loading tank.

A second aspect of the present invention is an apparatus for removing impurities from feed water comprising
(A) a loading tank comprising a top, a bottom, and an interior, and further comprising
   (i) an inlet that conveys the feed water to a water distributor near the bottom of the loading tank,
   (ii) a grid located above the water distributor, wherein the grid allows water to pass through the grid and wherein the grid does not allow particles of diameter larger than 10 μm to pass through the grid
   (iii) an outlet located at a level higher than the grid,
   (iv) an outlet at the bottom of the loading tank, wherein the outlet at the bottom of the loading tank is controlled by a switch that controllably allows material to pass through the outlet at the bottom of the loading tank,
(B) a regeneration tank comprising a top, a bottom, and an interior, and further comprising
   (i) a first inlet near the top of the regeneration tank,
   (ii) a second inlet at the top of the regeneration tank,
   (iii) an outlet at the bottom of the regeneration tank, wherein the outlet at the bottom of the regeneration tank is controlled by a switch that controllably allows material to pass through the outlet at the bottom of the regeneration tank,
(C) a pipe that conveys material from the bottom of the regeneration tank to the top of the loading tank,
wherein said regeneration tank is located below the loading tank so that material that exits the loading tank through the outlet at the bottom of the loading tank enters the regeneration tank through the second inlet at the top of the regeneration tank.

The following is a brief description of the drawings.

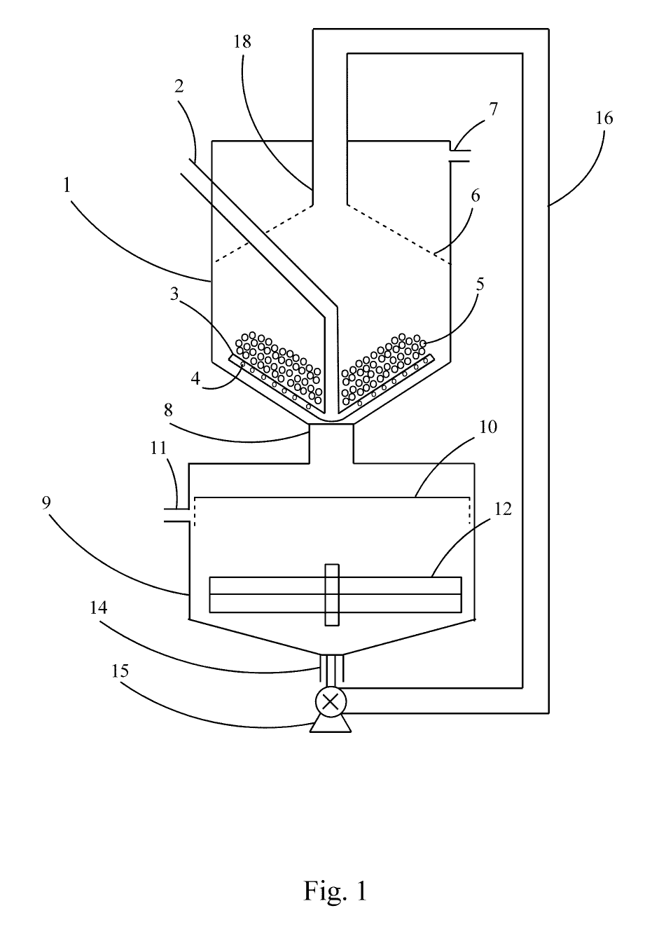

FIG. 1 shows an embodiment of the apparatus of the present invention.

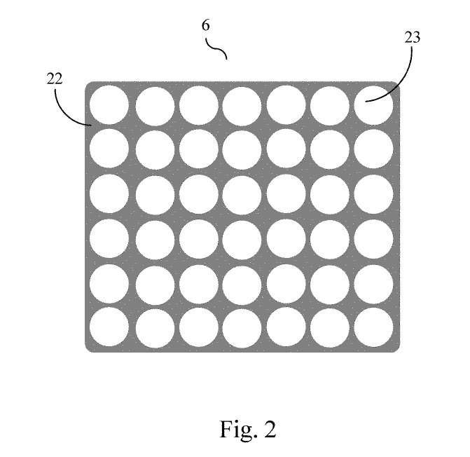

FIG. 2 shows a top view of one embodiment of the grid.

The following is a detailed description of the invention.

As used herein, the following terms have the designated definitions, unless the context clearly indicates otherwise.

As used herein, impurities are compounds that are dissolved in or carried by water. Ionic impurities are compounds that are dissolved in water and that, when dissolved in otherwise pure water at 25° C., half or more of the impurity, by weight based on the total weight of the impurity, is present in the water as one or more dissolved anions and one or more dissolved cations. All other impurities are nonionic impurities.

As used herein, feed water is any portion of water that contains one or more impurities.

As used herein, adsorbent resin is a polymer in the form of particles having volume average particle size of 1 μm to 1 mm. Adsorbent resin has surface are of 0.02 to 2,000 m²/g by the BET method. Some adsorbent resins are gel resins, which have pore size of less than 2 nm. Some adsorbent resins are macroporous resins, which have pore size of greater than 3 nm.

Some adsorbent resins are also ion exchange resins. Ion exchange resins have one or more functional group attached to the polymer, where that functional group is capable of ion exchange. Ion exchange is a process in which ions dissolved in a solution that is in contact with the polymer are exchanged for an equivalent amount of ions of identical charge released from the polymer; the ions formerly in the solution become adsorbed on the polymer. Some ion exchange resins are cation exchange resins, which exchange cations on the polymer with cations in solution. Some ion exchange resins are anion exchange resins, which exchange anions on the polymer with anions in solution.

The present invention involves removing impurities from feed water. The invention is most effective at removing impurities that are dissolved in water. Preferred impurities are dissolved ionic compounds, dissolved nonionic compounds having molecular weight or 500 or lower, and mixtures thereof; more preferred are dissolved ionic compounds; more preferred are dissolved inorganic salts. Preferably, the amount of dissolved nonionic organic compounds in the feed water is, 500 mg/L or lower; more preferably 200 mg/L or lower; more preferably 100 mg/L or lower.

In the process of the present invention, a collection of adsorbent resin particles is present in a loading tank. Near or on the bottom of the loading tank is a water distributor. If any of the collection of adsorbent resin particles is below the water distributor, the amount of adsorbent resin particles underneath the water distributor, by weight based on the weight of adsorbent resin particles present in the loading tank, is 10% or less; more preferably 5% or less. Preferably the bottom of the loading tank has a conical shape so that gravity pulls the adsorbent resin particles down toward the center of the bottom of the loading tank.

Near the top of the loading tank is a grid. The grid is any structure that allows liquid water to pass through the grid but prevents particles having diameter of larger than 0.5 μm from passing through the grid. The grid may be a flat woven wire structure or a flat plate with multiple holes. The grid may be, for example, a flat grid placed horizontally or tilted, or the grid may have a conical shape. Conveying structures such as pipes may need to pass through the grid; in such cases it is contemplated that the grid will fit tightly to the outside of such structures to prevent adsorbent resin particles from passing between the grid and the conveying structure. Preferably, all the adsorbent resin particles in the loading tank are located below the grid. Above the grid is an outlet that allows water to exit the loading tank.

The loading tank has a water inlet. The water inlet is a pipe that passes through the wall of the loading tank and connects with the water distributor. If the water inlet passes through the wall of the loading tank at a point above the grid, the water inlet also passes through the grid. The water inlet preferably connects to the water distributor at or near the center of the tank. Water in the water inlet is under pressure, so that water exits the water distributor and rises up to fill the loading tank until it reaches the outlet from the loading tank.

The water distributor releases water into the loading tank. Preferably, the water distributor releases water at a rate that does not vary significantly from one part of the tank to another. One preferred structure for the water distributor is a plurality of rods that are disposed radially at or near the bottom of the loading tank, where each rod has a plurality of holes to release water into the loading tank. Preferably, the rods and their holes are designed so that the rate that water is released (in mass of water per unit time) at any one point of the water distributor is within 20% of the rate that water is released at any other point of the water distributor.

Preferably, the bottom of the loading tank has a conical shape or other shape that slopes down to a single lowest point.

At the lowest point of the loading tank is an opening, controlled by a switch. The water distributor is disposed so that, when the opening is opened, adsorbent resin particles may freely pass down the loading tank and out through the opening at the bottom of the loading tank.

Preferably the adsorbent resin is an ion exchange resin.

It is contemplated that, as feed water exits the water distributor and comes into contact with the adsorbent resin particles, impurities will pass from the feed water to the adsorbent resin particles. Preferably, the adsorbent resin will be chosen to be effective at adsorbing impurities that are known to be present in the feed water. As the feed water contacts resin particles and moves upward in the loading tank, the feed water will gradually lose more and more impurities. Thus the adsorbent resin particles near the bottom of the loading tank will quickly become more highly contaminated with impurities than the adsorbent resin particles higher up in the loading tank.

Whenever a resin adsorbs an impurity from feed water, the resin eventually reaches a point of saturation, at which point the resin no longer adsorbs that impurity from the feed water. It is contemplated that, a fraction of the resin near the bottom of the loading tank reaches or nears such a saturation point for one or more of the impurities in the feed water, and the resin in that fraction is called herein the contaminated resin. It is desirable to remove that fraction of contaminated resin. This removal of contaminated resin allows the feed water, as it exits the water distributor, to encounter adsorbent resin particles that are neither nearly saturated nor saturated.

When it is desired to remove the contaminated adsorbent resin particles from the bottom of the loading tank, a switch is operated to open the opening at the bottom of the tank for a time long enough for that contaminated resin to drop out of the loading tank by the action of gravity.

While the switch is operated to open the opening at the bottom of the loading tank, the water may or may not continue to flow through the water inlet and out through the water distributor.

When the contaminated adsorbent resin particles exit the bottom of the loading tank, they enter the top of the regeneration tank. The resin particles may be allowed to fall immediately to the bottom of the regeneration tank. Optionally, a baffle is present near the top of the regeneration tank. The baffle provides a flat surface onto which the contaminated adsorbent resin particles fall and on which the contaminated adsorbent resin particles remain until the baffle is tilted, as a whole or in sections, to allow the resin particles to fall to the bottom of the regeneration tank. In some embodiments, several fractions of contaminated resin particles are allowed to fall onto the baffle before the baffle is tilted and the resin particles are allowed to fall to the bottom of the regeneration tank. The tilting of the baffle may be operated by a switch. The switch may be triggered manually or automatically. Automatic triggering may be initiated on a fixed time interval or by some preset criterion such as, for example, when a predetermined weight of resin particles is present on the baffle.

The regeneration tank has an inlet that allows regenerant liquid into the regeneration tank. Regenerant liquid is a liquid that allows the impurities to migrate from the contaminated adsorbent resin particles to the regenerant liquid. Preferred regenerant liquids are aqueous sodium chloride solutions, aqueous sodium hydroxide solutions, aqueous hydrochloric acid solutions, and mixtures thereof. For example, if an impurity is a small organic molecule, the regenerant liquid may be pure water or an organic solvent or a mixture thereof. For another example, if an impurity is an anion, the regenerant liquid may be a solution containing hydroxide ions. For another example, if an impurity is a cation, the regenerant liquid may be a solution of a mineral acid. The regeneration tank preferably has an agitator to improve the contact between the contaminated adsorbent resin particles and the regenerant liquid. The agitator is preferably a rotating element, preferably having a spiral shape.

The regeneration tank has a outlet for removal of regenerant fluid. The outlet is preferably located above the level reached by the contaminated adsorbent resin particles. The regeneration process may optionally involve several steps of introducing regenerant fluid, mixing with contaminated adsorbent resin particles, and removing regenerant fluid. When multiple steps are used, the regenerant fluids may be the same as each other or may be different from each other.

After the regeneration process, the level of impurities in the adsorbent resin is preferably much lower than the level of impurities that had been present in the contaminated resin, and the resin is referred to herein as purified resin. Preferably, the weight ratio of the impurities in the purified resin to the impurities in the contaminated resin is 0.1:1 to 0:1; more preferably 0.01:1 to 0:1.

Preferably, the bottom of the regeneration tank has a conical shape or other shape that slopes down to a single lowest point. The regeneration tank has an outlet at the bottom of the tank capable of removing resin from the regeneration tank. Preferably, that outlet is at the lowest point of the regeneration tank. The outlet is preferably controlled by a switch. The switch may be activated manually or automatically. When the switch is activated, the outlet is opened, and purified resin falls by the action of gravity out of the regeneration tank. The purified resin then encounters a pump that conveys the resin through a pipe to the loading tank, where the purified resin is deposited on top of the collection of adsorbent resin particles in the loading tank.

Regenerant liquid may be fed to the regeneration tank at the same time that feed water is fed to the loading tank. Independently, purified resin may be conveyed into the loading tank at the same time that feed water is fed into the loading tank.

The following is a description of the operation of the embodiment of the present invention shown in FIG. 1.

Feed water that contains impurities is fed into the loading tank 1 via inlet 2. Feed water is directed to the bottom of the loading tank 1. Feed water then enters the water distributor 3, which distributes the water throughout the bottom of the loading tank. In the embodiment shown in FIG. 1, the distributor 3 is a series of tubes that extend radially from the center of the bottom of the loading tank 1, and each tube has a plurality of holes 4 that allow the feed water to leave the water distributor 3 and enter the interior of the loading tank 1.

After the feed water exits the water distributor 3, it comes into contact with resin 5. The size of the resin beads 5 is enlarged in FIG. 1 for visual clarity. Also, the collection of resin beads in the interior of the loading tank 1 may occupy more of the volume of the interior of the loading tank 1 than is shown in FIG. 1. The feed water rises through the resin 5 and passes through the grid 6. Resin 5 does not pass through the grid 6. The feed water exits through outlet 7. It is contemplated that impurities from the feed water will be transferred to the resin 5 as the feed water travels upward through the resin 5. It is further contemplated that the resin 5 located near the bottom of loading tank 1 will have more contaminates per unit weight of resin 5 than the resin 5 located near the top of loading tank 1.

When it is desired to regenerate a portion of the resin 5, switch 8 is opened and a portion of resin 5 drops by gravity into regeneration tank 9 and falls onto baffle 10. Switch 8 may be opened under the control of an operator or opened automatically at a predetermined interval or opened automatically in response to a measurement of the contamination level of resin 5. Baffle 10 is located near the top of regeneration tank 9 and above rotating agitator 12. Rotating agitator 12 is located in the lower portion of regeneration tank 9. When the weight of the resin 5 resting on baffle 10 reaches a predetermined value, the baffle is opened (either automatically or under the control of an operator) and resin 5 falls by gravity into the lower portion of regeneration tank 9.

Regenerant liquid is injected into regeneration tank 9 via inlet 11. Regenerant liquid and resin 5 come into contact with each other in the lower portion of the regeneration tank 9. Contact between regenerant liquid and resin 5 is preferably enhanced by agitation of the mixture by rotation of rotating agitator 12. Impurities transfer from contaminated resin 5 to the regenerant liquid, and the regenerant liquid becomes contaminated. Optionally, further regenerant liquid is injected into regeneration tank 9 via inlet 11 while liquid is removed via an outlet (not shown). When resin 5 becomes sufficiently free of contaminants, water is injected into regeneration tank 9 via inlet 11, while liquid is removed from regeneration tank 9 via an outlet (not shown). Water will replace the contaminated regenerant liquid. Then regeneration tank 9 contains a mixture of purified resin 5 and water.

Then switch 14 is opened, and the mixture of resin 5 and water passes out of the bottom of regeneration tank 9. The mixture is driven by pump 15 through pipe 16 to the top of loading tank 1 and then injected into the interior of loading tank 1 through inlet 18. The resin introduced through inlet 18 will land on top of the resin already present in loading tank 1.

FIG. 2 is a top view of a portion of the grid 6. The holes 23 are small enough to block the passage of 99% (by weight) or more of the adsorbent resin particles and large enough that liquid water can readily pass through. The solid portion 22 of the grid prevents that passage of the adsorbent resin particles.

1. A method for removing impurities from feed water comprising
(a) providing a loading tank containing a collection of adsorbent resin particles, the collection having a top and a bottom,
(b) introducing the feed water into the bottom of the collection of the adsorbent resin particles,
(c) forcing the feed water upward through the collection of the adsorbent resin particles,
(d) passing the feed water through a grid located above the top of the collection of the adsorbent resin particles, wherein the grid prevents the passage of the adsorbent resin particles,
(e) allowing a portion of the collection of the adsorbent resin particles to fall from the bottom of the loading tank into a regeneration tank,
(f) introducing regenerant liquid into the regeneration tank,
(g) after steps (e) and (f), in the regeneration tank, forming a mixture of contaminated regenerant liquid and purified adsorbent resin particles,
(h) after step (g), removing the contaminated regenerant liquid from the regeneration tank,
(i) after step (h), introducing pure water into the regeneration tank to form a mixture of the pure water and the purified adsorbent resin particles,
(j) after step (i), conveying the mixture of pure water and purified adsorbent resin particles to the loading tank and introducing the mixture of pure water and purified adsorbent resin particles onto the top of the collection of the adsorbent resin particles in the loading tank.

2. The method of claim 1, wherein said regenerant tank comprises a baffle near the top of the regenerant tank, and wherein step (e) is
(e) allowing a portion of the collection of the adsorbent resin particles to fall from the bottom of the loading tank into a regeneration tank, to land on a baffle located near the top of the regeneration tank,

3. The method of claim 1, wherein said adsorbent resin particles are ion exchange resin particles.

4. The method of claim 1, wherein said step of forming a mixture of contaminated regenerant liquid and purified adsorbent resin particles comprises agitating a mixture of the regenerant liquid and the portion of the adsorbent resin particles in the regeneration tank.

5. An apparatus for removing impurities from feed water comprising
(A) a loading tank comprising a top, a bottom, and an interior, and further comprising
(i) an inlet that conveys the feed water to a water distributor near the bottom of the loading tank,
(ii) a grid located above the water distributor, wherein the grid allows water to pass through the grid and wherein the grid does not allow particles of diameter larger than 10 μm to pass through the grid
(iii) an outlet located at a level higher than the grid,
(iv) an outlet at the bottom of the loading tank, wherein the outlet at the bottom of the loading tank is controlled by a switch that controllably allows material to pass through the outlet at the bottom of the loading tank,
(B) a regeneration tank comprising a top, a bottom, and an interior, and further comprising
(i) a first inlet near the top of the regeneration tank,
(ii) a second inlet at the top of the regeneration tank,
(iii) an outlet at the bottom of the regeneration tank, wherein the outlet at the bottom of the regeneration tank is controlled by a switch that controllably allows material to pass through the outlet at the bottom of the regeneration tank,
(C) a pipe that conveys material from the bottom of the regeneration tank to the top of the loading tank,
wherein said regeneration tank is located below the loading tank so that material that exits the loading tank through the outlet at the bottom of the loading tank enters the regeneration tank through the second inlet at the top of the regeneration tank.

6. The apparatus of claim 4, wherein said regeneration tank comprises a baffle near the top of the regenerant tank.

7. The apparatus of claim 4, wherein the regeneration tank further comprises
(iv) a rotating agitator located near the bottom of the regeneration tank.

8. The apparatus of claim 4, wherein said water distributor comprises a plurality of holes that release water into the interior of the loading tank.
